(19) United States
(12) Patent Application Publication
(10) Pub. No.: US 2026/0029610 A1
(43) Pub. Date: Jan. 29, 2026

(54) OPTICAL MODULE AND WEARABLE DEVICE

(71) Applicant: GOERTEK OPTICAL TECHNOLOGY CO., LTD., Weifang, Shandong (CN)

(72) Inventor: Benhua Liu, Shandong (CN)

(73) Assignee: GOERTEK OPTICAL TECHNOLOGY CO., LTD., Weifang, Shandong (CN)

(21) Appl. No.: 18/996,933

(22) PCT Filed: Jul. 12, 2023
(86) PCT No.: PCT/CN2023/106999

§ 371 Date: Jan. 17, 2025

(30) Foreign Application Priority Data
Nov. 25, 2022 (CN) 202211490132.8

(51) Int. Cl. G02B 7/10; G02B 7/02; G02B 27/01

(52) U.S. Cl. CPC G02B 7/10; G02B 7/021; G02B 27/0149; G02B 27/0172; G02B 27/0179; G02B 2027/0154; G02B 2027/0178

(57) ABSTRACT

The disclosure provides an optical module and a wearable device. The optical module includes a lens group comprising at least a first lens consisting of a cut-edge lens; a lens barrel with an inner cavity, wherein the first lens is movably provided within the inner cavity; a guide slot, provided on a side wall of the lens barrel along an axial direction; a transmission member, through which a periphery of the first lens is slidably matched with the guide slot; a focusing ring, slidably provided on an outer side of the lens barrel; and an inclined slot, provided on a wall of the focusing ring close to the lens barrel, and the transmission member passes through the guide slot and is slidably connected to the inclined slot.

### CROSS-REFERENCE TO RELATED APPLICATIONS

The present disclosure is a National Stage of International Application No. PCT/CN2023/106999, filed on Jul. 12, 2023, which claims priority to Chinese Patent Application No. 202211490132.8, filed on Nov. 25, 2022, both of which are hereby incorporated by reference in their entireties.

### TECHNICAL FIELD

Embodiments of the present disclosure relates to the technical field of optical imaging, and particularly to an optical module and a wearable device.

### BACKGROUND

In recent years, Virtual Reality (VR) technology has been applied and rapidly developed in head mounted displays. The core component of VR technology is the optical module, and the quality of an image display by the optical module directly determines the quality of the head mounted display.

When a user uses the head mounted display, he or she typically wears the device over their heads, such as covering the eyes for a visual experience. However, there is considerable variation in users' vision, with some requiring glasses to achieve a clear image, while wearing both glasses and the head mounted display simultaneously may lead to an unsatisfactory user experience of a product.

Currently, the lens barrels used in VR devices are predominantly of a full circular structure. For these circular structures, the diopter adjustment can be realized by using the coaxial rotation of the rotating part to drive the lens to move along the axial direction of the lens barrel. To improve optical performance, however, it is necessary for the lens to increase the outer diameter according to optical designs. Increasing the outer diameter also leads to an increase in the outer diameter of the lens barrel, and the increase in the outer diameter of the lens barrel may cause the barrel to interfere with the wearer's brow eyebrow bone or nose, thereby affecting wearing comfort of the user. To address the issue of interference caused by the increased outer diameter of the lens barrel with the user's brow eyebrow bone or nose, it is necessary to perform edge cutting on the lens, resulting in an incomplete circular structure of the lens barrel. Consequently, it is no longer feasible to realize diopter adjustment by rotating the rotating part along the circumferential direction of the lens barrel to control the relative distance between the lens and the screen as in the original scheme.

### SUMMARY

An objective of the present disclosure is to provide new technical solutions for an optical module and a wearable device, which realizes the visual acuity adjusting function of the optical module of the cut-edge lens scheme, so that a user can watch a clear picture without wearing glasses.

In a first aspect, the present disclosure provides an optical module, which includes:
a lens group including at least a first lens which is a cut-edge lens;
a lens barrel with an inner cavity, the first lens is movably provided within the inner cavity, a guide slot is provided on a side wall of the lens barrel along an axial direction, and a periphery of the first lens is slidably matched with the guide slot via a transmission member; and
a focusing ring, wherein the focusing ring is slidably provided on an outer side of the lens barrel, an inclined slot is provided on a wall of the focusing ring close to the lens barrel, and the transmission member passes through the guide slot and is slidably connected to the inclined slot;
during focusing, the focusing ring is slid in a circumferential direction of the lens barrel, the inclined slot drives the transmission member to slide within the guide slot, so that the first lens is capable of moving translationally along the axial direction of the lens barrel to match a visual acuity of a target object.

Optionally, the optical module further includes a focusing ring retaining band;
the side wall of the lens barrel has a longitudinal section and an arcuate surface, the focusing ring retaining band is at least provided on the outer side of the arcuate surface, a slide groove is provided along circumferential direction of the focusing ring retaining band, and the focusing ring is located within the slide groove and is capable of moving along the slide groove.

Optionally, the focusing ring retaining band is a semi-annular structure and clips onto the outer side of the arcuate surface, and two sides of the focusing ring retaining band are each connected to the lens barrel via a fastener;
or, the focusing ring retaining band is a closed annular structure and is sleeved onto the side wall of the lens barrel, the focusing ring retaining band includes a first retaining band segment corresponding to the longitudinal section and a second retaining band segment corresponding to the arcuate surface, and the slide groove is provided on the second retaining band segment.

Optionally, the lens group further includes a second lens, the second lens is fixedly provided at one end of the lens barrel, and the first lens and the second lens are spaced apart and located on the same optical axis.

Optionally, the second lens is a cut-edge lens and has the same shape as the first lens, and a cut edge of the first lens corresponds to that of the second lens.

Optionally, the optical module further includes a lens holder where the first lens is fixedly provided, and the lens holder and the transmission member form an integral part.

Optionally, an outer wall of the focusing ring is provided with an anti-slip structure.

Optionally, the longitudinal section formed on the side wall of the lens barrel is configured to match a cut edge of the first lens.

Optionally, the optical module further includes a display screen provided on one end of the lens barrel, the display screen is provided on the same optical axis as the first lens, and the first lens is capable of moving linearly along the axis direction relative to the lens barrel to approach or move away from the display screen.

Optionally, the optical module further includes a rear end cover, which covers an end of the lens barrel and is provided with a assembling hole matching the display screen, and the display screen is provided within the assembling hole.

In a second aspect, the present disclosure provides a wearable device, which includes:
a housing; and
the optical module according to the first aspect, wherein the optical module is provided within the housing.

Optionally, the housing is a spectacle frame, which is provided with two lens frames;
there are provided two optical modules, and the two optical modules are separately provided within the two lens frames.

According to embodiments of the present disclosure, an optical module is provided, which may be applied to the optical scheme adopting the cut-edge lens. Based on the contour of the cut-edge lens being an incomplete circle, by providing a guide slot, which extends in the axial direction and cooperates with the inclined slot on the focusing ring, on the side wall of the lens barrel, it is possible to realize that the cut-edge lens even in the incomplete circular structure can also move linearly along the axial direction of the lens barrel with the rotation of the focusing ring, and thus realize diopter adjustment; the optical scheme of the present disclosure is suitable for the wearable device with an adjustable visual acuity, such that the user can still view the clear image without wearing glasses; additionally, the cut-edge lens scheme of the present disclosure can enhance wearing comfort.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 is a first schematic structural diagram of an optical module according to an embodiment of the present disclosure;

FIG. 2 is a cross-sectional view of an optical module according to an embodiment of the present disclosure;

FIG. 3 is an exploded view of the structure of an optical module according to an embodiment of the present disclosure;

FIG. 4 is a second schematic structural diagram of an optical module according to an embodiment of the present disclosure.

### DESCRIPTION OF REFERENCE SIGNS

10, first lens; 20, second lens; 21, second lens cut edge; 30, lens barrel; 31, first end face; 311, lens mounting hole; 32, second end face; 33, inner cavity; 34, side wall; 341, longitudinal section; 342, arcuate surface; 35, guide slot; 40, focusing ring; 41, inclined slot; 42, anti-slip structure; 50, lens holder; 51, transmission member; 60, focusing ring retaining band; 61, slide groove; 70, rear end cover; 71, assembling hole; 80, display screen; 90, fastener.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques and devices known to those skilled in the prior art may not be discussed in detail; however, such techniques and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

According to an aspect of an embodiment of the present disclosure, an optical module is provided, which is suitably applied to a Head mounted display (HMD), such as a VR HMD. The above VR headset may include, for example, VR glasses or a VR helmet, which is not specifically limited by the embodiment of the present disclosure.

In VR product design, take VR glasses as an example, in order to make the product avoid the user's nose bridge, eyebrow bone and other areas, it is possible to perform the edge-cutting process on the lens applied in the optical module so as to form an incomplete circular structure, and the corresponding lens barrels are formed into an incomplete circular shape. However, another problem caused by this is: due to the great difference in the eyesight of the users, it is necessary to adjust the distance between the lenses or between the lenses and the display to meet diopter adjustment (visual acuity), while after the edge of the lens is cut, the lens cannot be driven to move axially by rotation, and therefore the use requirements of people with different eyesight cannot be met.

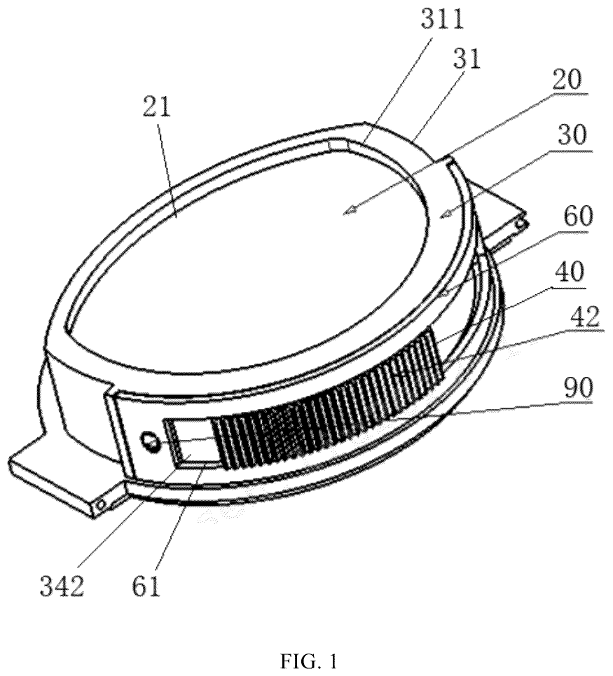

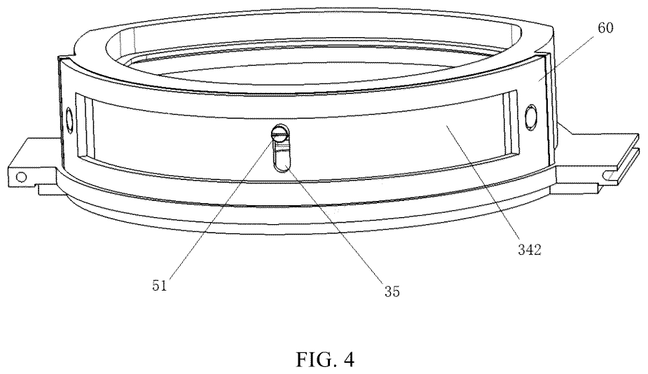

The embodiment of the present disclosure provides an optical module. As shown in FIGS. 1 to 4, the optical module includes: a lens group, a lens barrel 30 and a focusing ring 40; the lens group includes at least a first lens 10 which is a cut-edge lens; the lens barrel 30 has an inner cavity 33, the first lens 10 is movably provided within the inner cavity 33, a guide slot 35 is provided on a side wall 34 of the lens barrel 30 along an axial direction, and a periphery of the first lens 10 is slidably matched with the guide slot 35 via a transmission member 51; the focusing ring 40 is slidably provided on an outer side of the lens barrel 30, an inclined slot 41 is provided on a wall of the focusing ring 40 close to the lens barrel 30, and the transmission member 51 passes through the guide slot 35 and is slidably connected to the inclined slot 41;
during focusing, the focusing ring 40 is slid in a circumferential direction of the lens barrel 30, the inclined slot 41 drives the transmission member 51 to slide within the guide slot 35, so that the first lens 10 is capable of moving translationally along the axial direction of the lens barrel 30 to match a diopter of a target object.

The optical module provided by the embodiment of the present disclosure may be applied to the optical scheme adopting the cut-edge lens. Based on the fact that the profile of the cut-edge lens is an incomplete circular structure, referring to FIG. 1, by providing the guide slot 35 on the side wall 34 of the lens barrel 30 along the axial direction thereof so that it is matched with the inclined slot 41 on the focusing ring 40 along the circumferential direction, it is possible to realize that the cut-edge lens (i.e., the first lens 10 described above) in the incomplete circular structure, can also move linearly along the axial direction of the lens barrel 30 with the rotation of the focusing ring 40, so as to realize diopter adjustment. The optical scheme of the present disclosure is suitable for being applied to the wearable device with the adjustable visual acuity, and the user can still see clear images without wearing glasses.

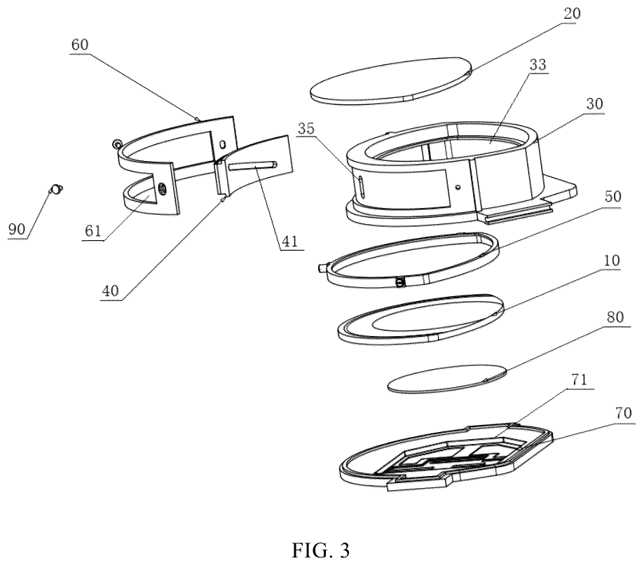

Referring to FIG. 3, the inclined slot 41 is provided on the inner wall surface of the focusing ring 40. The inner wall surface of the focusing ring 40 is positioned close to the outer wall of the lens barrel 30, such that the inclined slot 41 is not directly exposed to the outside, while the outer wall surface of the focusing ring 40 faces outward.

Moreover, since the optical module provided by embodiments of the present disclosure adopts a cut-edge lens design, it refers to a lens with an incomplete circular contour. Specifically, the edge of the above first lens 10 has been cut, wherein part of the edge area of the first lens 10 is removed, which allows the cut edge to avoid the user's brow eyebrow bone and nose bridge region. Meanwhile, the lens barrel that bears the first lens 10 can also be designed with a non-circular shape to match it, which contributes to enhancing wearing comfort.

The optical module disclosed in the embodiment of the present disclosure is designed such that the first lens 10 can move linearly along the axial direction of the lens barrel 30 within a set range, which may allow for adjusting the position of the first lens 10 inside the lens barrel 30, such as changing the distance between the first lens 10 and other lenses or the display screen 80 within the optical module, thereby enabling diopter adjustment to accommodate the user's visual acuity.

In the optical scheme provided by the embodiment of the present disclosure, the formed optical module can be used for people with different visual acuities, which can enhance the use experience of the user who need to wear glasses, such that the users can match their own visual acuity through the visual acuity adjustment function of the optical module without wearing glasses.

In the embodiment of the present disclosure, the first lens 10 can be slidably matched with the guide slot 35 on the lens barrel 30 and the inclined slot 41 on the focusing ring 40 via the transmission member 51. Here, the transmission member 51, which is connected to the first lens 10, is movably inserted into the guide slot 35 and extends out through the guide slot 35 to be inserted into the inclined slot 41.

When the focusing ring 40 is controlled to rotate, the rotation of the focusing ring 40 can drive the inclined slot 41 to slide back and forth along the transmission member 51. Based on the slope trend of the inclined slot 41, the transmission member 51 can be driven to be stressed along the axial direction of the lens barrel 30 and produce linear motion within the guide slot 35. After the lens barrel 30 carrying the first lens 10 presents an incomplete circular structure, the first lens 10 can still be controlled to move in the axial direction relative to the lens barrel 30 by adjusting the rotation of the focusing ring 40, thereby adjusting the diopter of the optical module. The design in the present disclosure remedies the following difficulty in the prior art; the cut-edge lens scheme is unable to control the axial movement of the lens by rotating the rotating member in the circumferential direction of the lens barrel to achieve diopter adjustment.

Optionally, the rotation of the focusing ring 40 can for example be driven by a drive mechanism. Of course, the rotation of the focusing ring 40 can also be manually driven. The present disclosure does not limit the method of driving the focusing ring 40 to rotate.

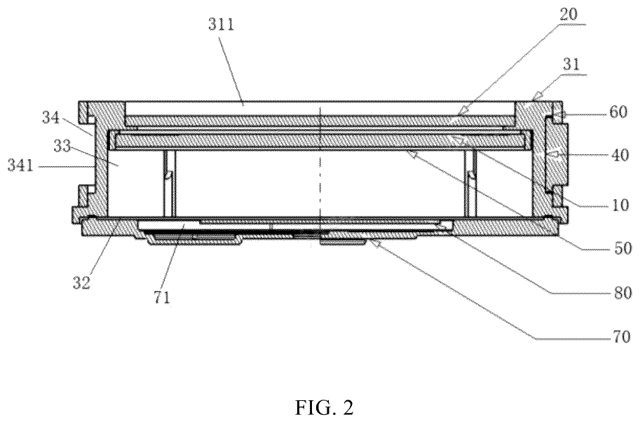

The optical module provided by the embodiments of the present disclosure, as shown in FIG. 1 and FIG. 2, for example, includes a lens group that comprises at least one lens; simultaneously, within the lens group, a beam-splitting element, a phase retarder, and a polarization-reflecting element can also be provided, making the entire optical module form a folded optical path (pancake) structure.

For example, the lens group includes only a single first lens 10. The lens group further includes a beam-splitting element, a phase retarder, and a polarization-reflecting element. These optical elements (optical films) can be placed at appropriate positions on two sides of the first lens 10 such that the optical module forms a folded optical path, and the imaging light travels back and forth within the folded optical path, which can extend the propagation path of the light and facilitates final clear imaging.

In the optical module of the embodiments of the present disclosure, the number of lenses is not limited to the above one but can be flexibly adjusted according to specific needs. Here, with the increase in the number of lenses, although the imaging quality of the optical module can be improved, the size of the optical module along the optical axis direction (horizontally) will also be affected, leading to a larger volume and increased weight of the optical module.

Optionally, when two lenses are provided in the optical module, one lens can be designed to be fixed on the lens barrel 30 without moving, while the other lens (such as the above first lens 10) can move within a certain range along the axis direction of the lens barrel 30, so as to enable adjustment of the distance between the two lenses, thereby adapting to the user's visual acuity.

It should be noted that when there are two or more lenses provided in the optical module, the number of fixed lenses and movable lenses can be designed according to specific needs, which is not specifically limited in the embodiment of the present disclosure.

Here, the beam-splitting element, for example, is a transflective device, which allows a portion of the light to transmit and reflects another portion of the light. The reflectivity of the beam-splitting element, for example, is 47% to 53%.

Here, the phase retarder, for example, is a quarter-wave plate. Of course, the phase retarder here can also be set as other phase retardation plates such as half-wave plates according to needs. The phase retarder can be used to change the polarization state of light. For example, it can convert linearly polarized light into circularly polarized light or vice versa.

Here, the polarization-reflecting element is a polarization reflector that reflects horizontally linearly polarized light and transmits vertically linearly polarized light, or a polarization reflector that reflects linearly polarized light of any other specific angle and transmits linearly polarized light in a direction perpendicular to the angle.

In the embodiment of the present disclosure, the phase retarder and the polarization-reflecting element work together to analyze and transmit light.

Here, the beam-splitting element, the phase retarder, and the polarization-reflecting element can be arranged relatively flexibly within the lens group, for example, on either side of the above first lens 10 or distributed on both sides, but it must be ensured that the phase retarder is located between the beam-splitting element and the polarization-reflecting element.

In some examples of the present disclosure, referring to FIG. 1 and FIG. 2, the optical module further includes a focusing ring retaining band 60; the side wall 34 of the lens barrel 30 has a longitudinal section 341 and an arcuate surface 342, the focusing ring retaining band 60 is at least provided on the outer side of the arcuate surface 342, a slide groove 61 is provided along circumferential direction of the focusing ring retaining band 60, and the focusing ring 40 is located within the slide groove 61 and is capable of moving along the slide groove 61.

The focusing ring retaining band 60 presses against the focusing ring 40 and can envelop the outer periphery of the focusing ring 40. This design can effectively prevent the focusing ring 40 from falling off, that is, avoid the separation of the focusing ring 40 from the lens barrel 30 during long-term repeated focusing adjustments, thereby extending service life.

When the first lens 10 in the optical module is a cut-edge lens, it has at least one cut edge.

On this basis, the lens barrel 30 used to bear the first lens 10 has a longitudinal section 341 on its side wall 34 that matches the cut edge of the first lens 10.

The longitudinal section 341 formed on the side wall 34 of the lens barrel 30 can provide reasonable clearance for the user's nasal bridge region or eyebrow bone region.

Optionally, referring to FIG. 1, the focusing ring retaining band 60 is a semi-annular structure and clips onto the outer side of the arcuate surface 342, and two sides of the focusing ring retaining band 60 are each connected to the lens barrel 30 via a fastener 90;
or, the focusing ring retaining band 60 is a closed annular structure and is sleeved onto the side wall 34 of the lens barrel 30, the focusing ring retaining band 60 includes a first retaining band segment corresponding to the longitudinal section 341 and a second retaining band segment corresponding to the arcuate surface 342, and the slide groove 61 is provided on the second retaining band segment.

Here, the focusing ring retaining band 60 can be made of flexible material, such as rubber material, which can deform according to need to be sleeved over the lens barrel 30 and match the shape of the lens barrel 30. The focusing ring retaining band 60 is pressed between the focusing ring 40 and the lens barrel 30, and can also play the role of sealing.

For example, one structural form of the focusing ring retaining band 60 is a closed annular structure, and can be directly sleeved over the outer side of the lens barrel 30. This structural design is suitable for both complete circular structures of the lens barrel and the incomplete circular structure of the lens barrel 30 in the present disclosure, offering broad applicability.

The focusing ring retaining band 60, in order to cooperate with the incomplete circular lens barrel 30, can be divided into two segments: one segment is the above first retaining band segment, which is, for example, used to enclose the outer side of the longitudinal section 341; the other segment is the above second retaining band segment, which is, for example, used to enclose the outer side of the arcuate surface 342. It should be noted that the present disclosure utilizes the second retaining band segment on the outer side of the arcuate surface 342 of the lens barrel 30 to provide an arc-shaped slide groove 61 along which the focusing ring 40 can rotate, and then drive the transmission member 51 to move within the guide slot 35, thereby converting rotational drive into axial movement of the first lens 10.

For another example, the focusing ring retaining band 60 can be designed as a semi-annular structure, and can be directly attached to the outer side of the arcuate surface 342 of the lens barrel 30. The outer side of the longitudinal section 341 of the lens barrel 30 can be left without providing the focusing ring retaining band 60, which can save costs. Here, the two sides of the focusing ring retaining band 60 can be connected to the side wall 34 of the lens barrel 30 via the fastener 90. Here, the fastener 90, for example, is a fixing screw, so as to more firmly connect the focusing ring retaining band 60 to the lens barrel 30.

In some examples of the present disclosure, referring to FIG. 1 and FIG. 2, the lens group further includes a second lens 20, the second lens 20 is fixedly provided at one end of the lens barrel 30, and the first lens 10 and the second lens 20 are spaced apart and located on the same optical axis.

In the embodiments of the present disclosure, considering a plurality of factors such as the volume, weight, imaging quality, and production cost of the optical module, it is more preferable to design two lenses in the optical path, namely the above first lens 10 and second lens 20; wherein, the second lens 20, for example, is fixed on the lens barrel 30 without moving, while the first lens 10 can move closer to or farther away from the second lens 20 along the axis direction of the lens barrel 30. By adjusting the distance between these two lenses, it is possible to perform visual acuity adjustment.

It should be noted that the first lens 10 and the second lens 20 can be on the same optical axis. When the first lens 10 is moved relative to the second lens 20, it can be moved along the optical axis direction.

For example, see FIG. 2, a lens installation hole 311 is provided on the first end face 31 of the lens barrel 30, and the second lens 20 can be fixedly provided within this lens installation hole 311. Here, the first end face 31 of the lens barrel 30, when in use, is designed to be on the side close to the human eye.

In the optical module proposed by the embodiment of the present disclosure, the lens barrel 30, for example, is a hollow structure with two opposite end surfaces, like the first end face 31 and the second end face 32. The lens installation hole 311 can be opened on the first end face 31 to assemble the second lens 20, thus fixing the second lens 20 on the lens barrel 30 while the position of the second lens 20 is relatively fixed.

Optionally, the second lens 20 includes a body and an installation part surrounding its edge, and the second lens 20, for example, is fixed within the lens installation hole 311 through the installation part.

The lens holder 50 leads the first lens 10 to move relative to the lens barrel 30, and the two form a transmission fit therebetween, so as to adjust the distance between the first lens 10 and the second lens 20.

In the above example, optionally, the second lens 20 is a cut-edge lens, and the second lens 20 has the same shape as the first lens 10.

When the optical module also includes the second lens 20, and the second lens 20, the first lens 10, and the display screen 80 are all on the same optical axis. As the first lens 10 moves translationally, the distance between the first lens 10 and the second lens 20 also changes.

In the optical module provided by the embodiments of the present disclosure, both the first lens 10 and the second lens 20 can be provided as cut-edge lenses. During the assembly of the optical module, it should be ensured that the first cut edge of the first lens 10 corresponds to the second cut edge 21 of the second lens 20.

Both the first lens 10 and the second lens 20 have a non-circular outline, such that the lens barrel 30 bearing them also form an incomplete circular structure accordingly, which can provide clearance for the user's nasal bridge region or eyebrow bone region in terms of appearance, and facilitate the product shape design of VR devices such as VR smart glasses.

In some examples of the present disclosure, referring to FIG. 1 and FIG. 2, the optical module further includes a lens holder 50 where the first lens 10 is fixedly provided, and the lens holder 50 is connected to the transmission member 51.

In the optical module proposed by the present disclosure, the lens barrel 30 may bear the above first lens 10 and second lens 20, and even more lenses.

Here, the first lens 10 can be fixedly provided in a lens holder 50, and then the lens holder 50 is provided in the inner cavity 33 of the lens barrel 30. It should be noted that the lens holder 50 is not fixedly connected to the lens barrel 30; instead, the lens holder 50 can move linearly relative to the lens barrel 30. In this way, as the lens holder 50 moves, the first lens 10 may adjust the distance between the second lens 20 and the first lens 10, so as to achieve the purpose of diopter adjustment, thereby meeting the usage needs of people with different visual acuities.

Here, the lens holder 50, for example, is a ring-shaped thin plate structure, with a hollow region formed in the middle for installing the first lens 10. The lens holder 50 is simple in structure and easy to be assembled into the lens barrel 30.

Optionally, the transmission member 51 is a transmission rod, which is provided on the peripheral side of the lens holder 50. That is, the transmission member 51 can form an integrated structure with the lens holder 50.

Optionally, the external contour of the first lens 10 matches the shape of the hollow region. Further, the first lens 10, for example, is fixed within the hollow region by adhesive bonding, so that the first lens 10 and the lens holder 50 form an integral structure. In this way, when the lens holder 50 moves, it can lead the first lens 10 to move together with it.

Additionally, the first lens 10 can also be provided on the first end face 31 of the lens barrel 30 by adhesive bonding. For example, the first end face 31 is on the side close to the human eye.

For example, the lens barrel 30 also has a second end face 32, opposite to the first end face 31. The second end face 32, for example, is in an open state, which allows light to pass through and enter the lens group. Specifically, when the first end face 31 faces the human eye, the second end face 32 is away from the human eye and is on the side of the optical module where the display screen 80 is provided (see FIG. 1 and FIG. 2 showing the display screen 80, and the discussion of the position of the display screen follows).

In the embodiments of the present disclosure, the length of the guide slot 35 and the inclined slot 41, as well as the inclination of the inclined slot 41, can be designed according to needs. These two aspects can limit the movement range of the first lens 10, thereby realizing diopter adjustment of the corresponding range.

In some examples of the present disclosure, referring to FIG. 1, an outer wall of the focusing ring 40 is provided with an anti-slip structure 42.

The anti-slip structure 42, for example, is a continuous ribbed structure. Of course, it can also be other pattern structures, and used to prevent the focusing accuracy from being affected by slippage when the focusing ring 40 is rotated manually.

That is, the inclined slot 41 and the anti-slip structure 42 are provided on opposite surfaces of the focusing ring 40 respectively. The inclined slot 41 is located on the inner side and is not directly exposed, while the anti-slip structure 42 is directly exposed and can be contacted by the user during manual adjustment.

In some examples of the present disclosure, referring to FIG. 1 and FIG. 2, the optical module further includes a display screen 80 provided on one end of the lens barrel 30, the display screen 80 is provided on the same optical axis as the first lens 10, and the first lens 10 is capable of moving linearly along the axis direction relative to the lens barrel 30 to approach or move away from the display screen 80.

As the first lens 10 moves within the lens barrel 30, it is possible to adjust the distance between the first lens 10 and the display screen 80 to achieve visual acuity adjustment.

In the above embodiment, referring to FIG. 1 and FIG. 2, the optical module further includes a rear end cover 70, which covers an end of the lens barrel 30 and is provided with a assembling hole 71 matching the display screen 80, and the display screen 80 is provided within the assembling hole 71.

In a specific embodiment of the present disclosure, referring to FIGS. 1 to 4, the optical module includes the first lens 10, the second lens 20, the lens barrel 30, the focusing ring 40, the lens holder 50, the focusing ring retaining band 60, the rear end cover 70, and the display screen 80; wherein, the first lens 10 and the second lens 20 are both provided as cut-edge lenses and have the same shape; the lens barrel 30 has the inner cavity 33, and the guide slot 35 is provided on a side wall 34 of the lens barrel 30 along an axial direction;
the first lens 10 is fixedly provided within the lens holder 50, and the lens holder 50 is located within the inner cavity 33, and is connected to the transmission member 51; the focusing ring 40 is slidably provided on an outer side of the lens barrel 30, and the outer wall of the focusing ring 40 is provided with an anti-slip structure 42, and the inner wall of the focusing ring 40 is provided with the inclined slot 41, and the transmission member 51 passes through the guide slot 35 first and then is slidably connected to the inclined slot 41; the side wall 34 of the lens barrel 30 has a longitudinal section 341 and an arcuate surface 342, and the longitudinal section 341 is configured to match a cut edge of the first lens 10;
the focusing ring retaining band 60 is a semi-annular structure and clips onto the outer side of the arcuate surface 342, and both sides of the focusing ring retaining band 60 are connected to the lens barrel 30 via a fastener 90, the focusing ring retaining band 60 is opened with a slide groove 61, and the focusing ring 40 is located within the slide groove 61;
the second lens 20 is fixedly provided on the first end face 31 of the lens barrel 30, and the first lens 10 and the second lens 20 are spaced apart and on the same optical axis;
the rear end cover 70 covers the second end face 32 of the lens barrel 30, and the rear end cover 70 is provided with an assembling hole 71, the display screen 80 is provided within the assembling hole 71, and is on the same optical axis as the first lens 10 and the second lens 20;
during focusing, by rotating the focusing ring 40, the inclined slot 41 drives the transmission member 51 to slide within the guide slot 35, so that the first lens 10 is capable of moving translationally along the axial direction of the lens barrel 30 to approach or move away from the display screen 80, so as to match the visual acuity of the target object.

According to another aspect of the embodiment of the present disclosure, an wearable device is also provided, which includes a housing and the optical module as described above, and the optical module is provided within the housing.

The wearable device, for example, is a VR head mounted device, including VR glasses or a VR helmet, etc., which is not specifically limited by the embodiment of the present disclosure.

For example, the housing is a spectacle frame, which is provided with two lens frames; there are provided two optical modules, and the two optical modules are separately provided within the two lens frames.

The specific implementation of the head mounted display of the embodiments of the present disclosure can refer to the various embodiments of the above optical module, and thus has at least all the beneficial effects brought by the technical solutions of the above embodiments, which will not be repeated herein one by one.

The above embodiments focus on the differences between the various embodiments, and the different optimization features between the various embodiments, as long as they do not contradict each other, may be combined to form a better embodiment, which will not be repeated herein taking into account the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module, comprising:
a lens group comprising at least a first lens consisting of a cut-edge lens;
a lens barrel with an inner cavity, wherein the first lens is movably provided within the inner cavity;
a guide slot, is provided on a side wall of the lens barrel along an axial direction;
a transmission member, through which a periphery of the first lens is slidably matched with the guide slot via a transmission member;
a focusing ring, slidably provided on an outer side of the lens barrel; and
an inclined slot, provided on a wall of the focusing ring close to the lens barrel, and the transmission member passes through the guide slot and is slidably connected to the inclined slot;
wherein the focusing ring is configured to be slid in a circumferential direction of the lens barrel, and the inclined slot is configured to drive the transmission member to slide within the guide slot, so that the first lens moves translationally along the axial direction of the lens barrel to match a visual acuity of a target object for focusing.

2. The optical module according to claim 1, further comprises a focusing ring retaining band;
wherein the side wall of the lens barrel has a longitudinal section and an arcuate surface, the focusing ring retaining band is provided on the outer side of the arcuate surface, a slide groove is provided along a circumferential direction of the focusing ring retaining band, and the focusing ring is located within the slide groove and is configured to move along the slide groove.

3. The optical module according to claim 2, wherein the focusing ring retaining band is a semi-annular structure and clipped onto the outer side of the arcuate surface, and each of two sides of the focusing ring retaining band is connected to the lens barrel via a fastener;
or, the focusing ring retaining band is a closed annular structure sleeved onto the side wall of the lens barrel, the focusing ring retaining band comprises a first retaining band segment corresponding to the longitudinal section and a second retaining band segment corresponding to the arcuate surface, and the slide groove is provided on the second retaining band segment.

4. The optical module according to claim 1, wherein the lens group further comprises a second lens fixedly provided at a first end of the lens barrel, and the first lens and the second lens are spaced apart and located on the same optical axis.

5. The optical module according to claim 4, wherein the second lens is a cut-edge lens having the same shape as the first lens, with a cut edge corresponding to that of the first lens.

6. The optical module according to claim 1, further comprises a lens holder where the first lens is fixedly provided, and the lens holder and the transmission member form an integral part.

7. The optical module according to claim 1, wherein an outer wall of the focusing ring comprises an anti-slip structure.

8. The optical module according to claim 2, wherein the longitudinal section formed on the side wall of the lens barrel is configured to match a cut edge of the first lens.

9. The optical module according to claim 1, further comprising a display screen provided on a second end of the lens barrel, the display screen is provided on the same optical axis as the first lens, such that the first lens is configured for a movement linearly along the axis direction relative to the lens barrel to approach or move away from the display screen.

10. The optical module according to claim 9, wherein the optical module further comprises a rear end cover, which covers an end of the lens barrel and is provided with a assembling hole matching the display screen, and the display screen is provided within the assembling hole.

11. A wearable device, characterized by comprising:
a housing; and
an optical module according to claim 1, provided within the housing.

12. The wearable device according to claim 11, wherein the housing comprises a spectacle frame two lens frames;
wherein two optical modules are separately provided within the two lens frames.
